(19) United States
(12) Patent Application Publication
(10) Pub. No.: US 2026/0323111 A1
(43) Pub. Date: Oct. 15, 2026

(54) UNIFIED CONTROL OF HETEROGENEOUS CONTENT DELIVERY IN HOSPITALITY ENVIRONMENTS

(71) Applicant: Sonifi Solutions, Inc., Sioux Falls, SD (US)

(72) Inventors: Eric Aasen, Sioux Falls, SD (US); Joshua H. Pulford, Sioux Falls, SD (US); Kara Heermans, Beresford, SD (US)

(73) Assignee: Sonifi Solutions, Inc., Sioux Falls, SD (US)

(21) Appl. No.: 19/644,935

(22) Filed: Apr. 10, 2026

Related U.S. Application Data
(60) Provisional application No. 63/786,588, filed on Apr. 10, 2025.

(51) Int. Cl. H04N 21/426; H04N 21/431; H04N 21/472

(52) U.S. Cl. CPC H04N 21/4263; H04N 21/4316; H04N 21/47202

(57) ABSTRACT

A system includes a set-top-box (STB) that has at least a first communication interface, a second communication interface, and at least one processor. The at least one processor is to receive a user command corresponding to a request for content to be output by a display device, determine, based on the user command, whether the display device natively supports providing the content, generate and send, when the display device natively supports providing the content, at least one control signal through the first communication interface of the STB to control the display device to natively provide the content, and generate and send, when the display device does not natively support providing the content, a display signal including the content through the second communication interface of the STB to cause the display device to output the content.

### FIELD

Example embodiments are generally directed to providing unified control of heterogeneous content delivery, particularly within hospitality environments.

### BACKGROUND

Hospitality environments often include centrally controlled entertainment systems to provide broadcast and on-demand television services for guests.

### SUMMARY

At least one illustrative embodiment is directed to a system including a set-top-box (STB) that has at least a first communication interface, a second communication interface, and at least one processor. The at least one processor is to receive a user command corresponding to a request for content to be output by a display device, determine, based on the user command, whether the display device natively supports providing the content, generate and send, when the display device natively supports providing the content, at least one control signal through the first communication interface of the STB to control the display device to natively provide the content, and generate and send, when the display device does not natively support providing the content, a display signal including the content through the second communication interface of the STB to cause the display device to output the content.

Another illustrative embodiment is directed to a method that includes receiving, by a set-top-box (STB), a user command corresponding to a request for content to be output by a display device, determining, by the STB and based on the user command, whether the display device natively supports the content, generating and sending, when the display device natively supports the content, at least one control signal through a first communication interface of the STB which causes a tuner of the display device to tune to the content, and generating and sending, when the display device does not natively support the content, a display signal including the content through a second communication interface of the STB to cause the display device to output the content.

Yet another illustrative embodiment is directed to a system that includes a first communication interface for sending control signals to a display device, a second communication interface for sending display signals to the display device, memory comprising instructions, and at least one processor to execute the instructions to cause the display device to render an electronic program menu via the second interface, where the electronic program menu comprising content options for viewing by a user of the display device, receive a signal corresponding to a user command that selects a content option from the electronic program menu, determine whether the display device natively supports providing content of the selected content option based on a mapping of the content options to capabilities of the display device, the STB, or both, and utilize, based on the determination, the first communication interface, the second communication interface, or both to provide the content to the display device.

### BRIEF DESCRIPTION OF THE FIGURES

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 illustrates a system for providing unified control of heterogenous content according to at least one example embodiment.

FIG. 2 illustrates an environment for the system in FIG. 1 according to at least one example embodiment.

FIG. 3 illustrates a diagram showing details for some elements in the system of FIG. 1 according to at least one example embodiment.

FIG. 4 illustrates a method for providing unified control of heterogenous content according to at least one example embodiment.

### DETAILED DESCRIPTION

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Alternatively or additionally, functions may be implemented using machine learning models, neural networks, artificial neural networks, or combinations thereof (alone or in combination with instructions). Computer-readable media (also termed “memory”) may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions stored on memory may be executed by one or more processors described herein, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), graphics processing units (e.g., Nvidia GeForce RTX 2000-series processors, Nvidia GeForce RTX 3000-series processors, AMD Radeon RX 5000-series processors, AMD Radeon RX 6000-series processors, or any other graphics processing units), application specific integrated circuits (ASICs), field programmable gate arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

Example embodiments are directed to systems, devices, and methods that enable a Set-Top Box (STB) or similar device to seamlessly manage and present both over-the-top (OTT) streaming content (e.g., NETFLIX, HULU, PEACOCK, and/or other application-based streaming services) and legacy linear television services (e.g., coaxial cable, Internet Protocol (IP) multicast) on a commercially available hospitality television. The STB leverages the television's integrated tuner and decryption capabilities, eliminating the need for redundant hardware within the STB. In some embodiments, a software application running on the STB dynamically determines the content delivery mechanism and issues control commands to the television (also termed a display and a display device herein) via a command and control interface (e.g., Master TV Interface/Management Protocol Interface (MTI/MPI)). The software application may be downloaded to the STB on-property by way of an off-site server that also performs pairing of user devices to STBs/TVs or may be installed prior to on-property deployment. In any event, example embodiments allow for a unified user experience across diverse content sources.

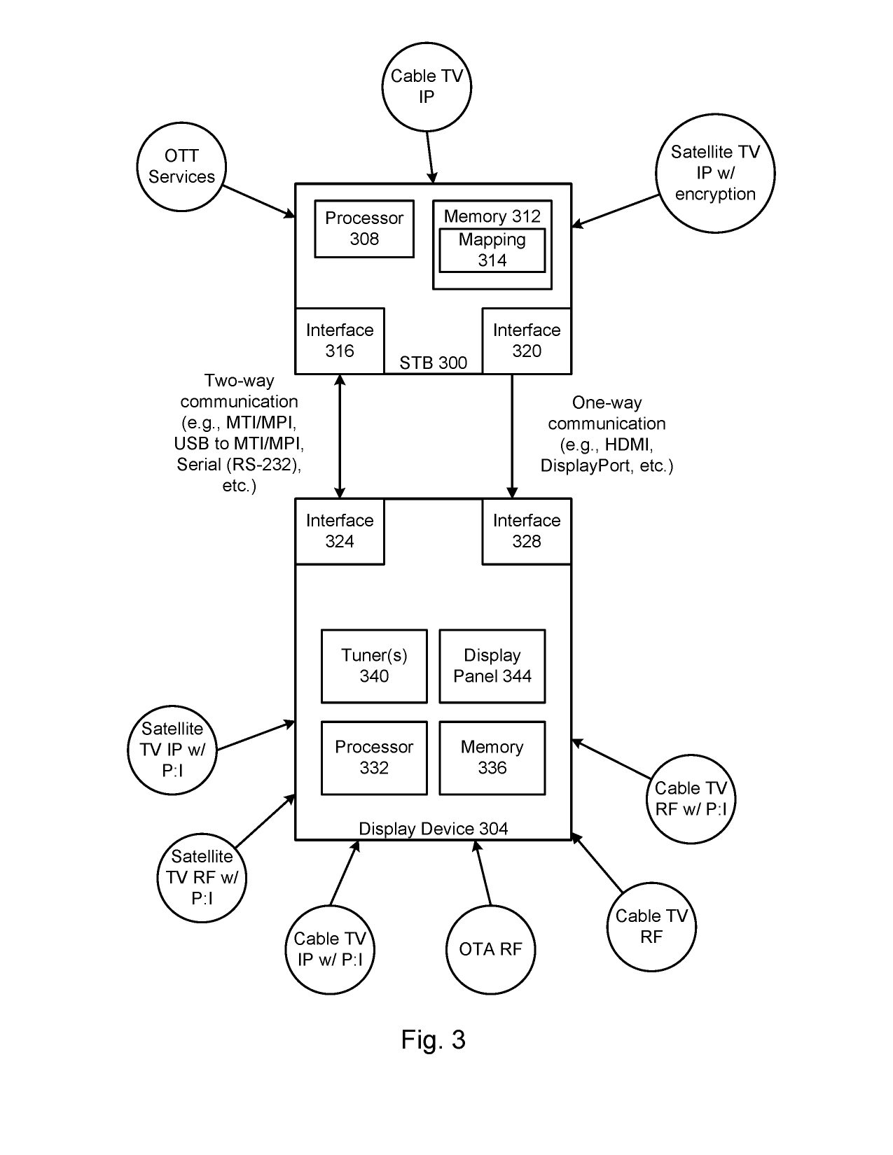

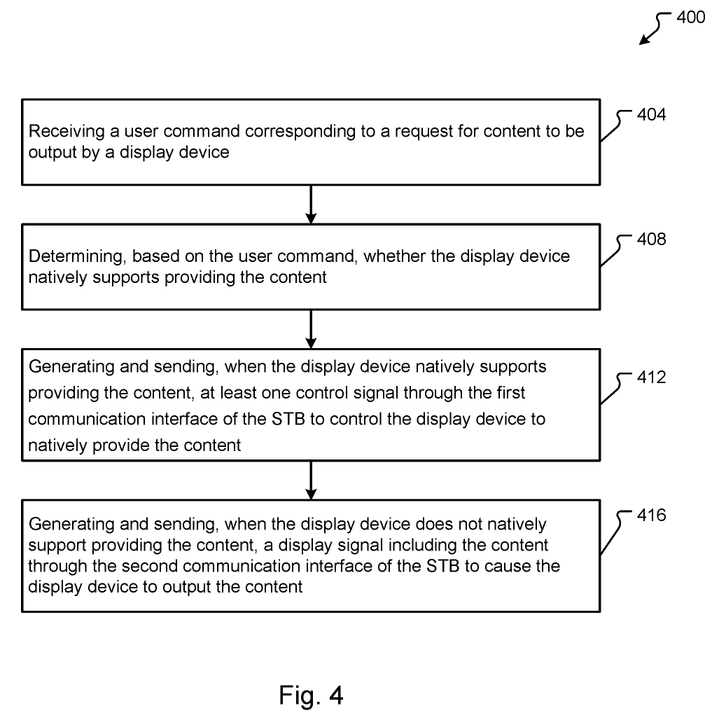

Systems and method described herein enable heterogeneous content management and address the challenges of integrating modern, resource-constrained STBs with legacy content delivery systems, such as quadrature amplitude modulation (QAM)-based coaxial cable television or IP multicast linear TV. In some examples, the STB software maintains a database or mapping that correlates user-selectable content options with their respective delivery mechanisms (OTT, QAM, IP). Embodiments of the present disclosure may further relate to dynamic content source switching. For example, upon user selection of an OTT service or other service not natively supported by the TV, the STB functions as a streaming device, requesting, decrypting, decoding, and rendering the requested content via its HDMI output to the television (see FIGS. 3 and 4). When a user selects a linear television service (QAM or IP) or other service that is natively supported by the TV, the STB issues control commands to the television via a defined command and control interface (e.g., MTI/MPI, universal serial bus (USB), serial (e.g., RS-232), or other). These commands instruct the television to tune to the specific channel or IP address associated with the user's selection and switch the television's input source from the input connected to the STB's high-definition multimedia interface (HDMI) output to the television's internal tuner or IP decryption module. As may be appreciated, the television’s input source is switched automatically and without giving any indication to the user which is contrary to normal methods which require user input on a remote control of the TV and/or input to the TV itself to switch inputs.

Example embodiments may provide a seamless user entertainment experience regardless of content requested to be viewed. When a user navigates away from linear television or other service that is natively supported by the TV (e.g., by accessing a menu, interactive program guide (IPG), or an OTT application), the STB issues commands through the command and control interface to the television to switch the TV back to the input connected to the STB's HDMI output, restoring the STB's user interface. In some examples, the STB intercepts and processes channel change commands (e.g., channel up/down) received from the user's remote for services accessed through the STB and the TV. The STB then determines the selected channel's delivery mechanism (QAM, IP, or OTT) and issues the appropriate control commands to the television or manages the OTT stream accordingly, creating a seamless channel surfing experience. Systems and method described herein allow for a unified Electronic Program Guide (EPG) experience, where all content types (OTT streaming content and linear content) are shown together, but the STB is aware of the content type, and controls the TV accordingly. Stated another way, OTT streaming content and linear content may be selectable from the same guide without the user necessarily being aware that the STB is passing commands to the TV to switch inputs depending on the type of content selected, thus providing the seamless experience.

Systems described herein may also achieve improved hardware utilization. For example, by leveraging the television's integrated tuner and decryption capabilities, the STB can be designed with minimal hardware requirements, reducing cost and complexity. The architecture described herein is not limited to QAM-based linear television and be extended to support other linear delivery mechanisms, such as IP multicast, provided the television supports the necessary decryption and control interfaces.

Here, it should be appreciated that the terms “guest” used herein is intended to cover individuals who are officially registered as a guest of a hotel or a patient of hospital as well as individuals that are not officially registered guests or patients but who are located within the property 200 and using the property’s resources. The term “entertainment provider” as used herein should be understood to include the entity which exerts control over in-property networks that connect guests to various entertainment options and/or the Internet. An entertainment provider may cooperate with owners or managers of properties 200 to provide such entertainment options.

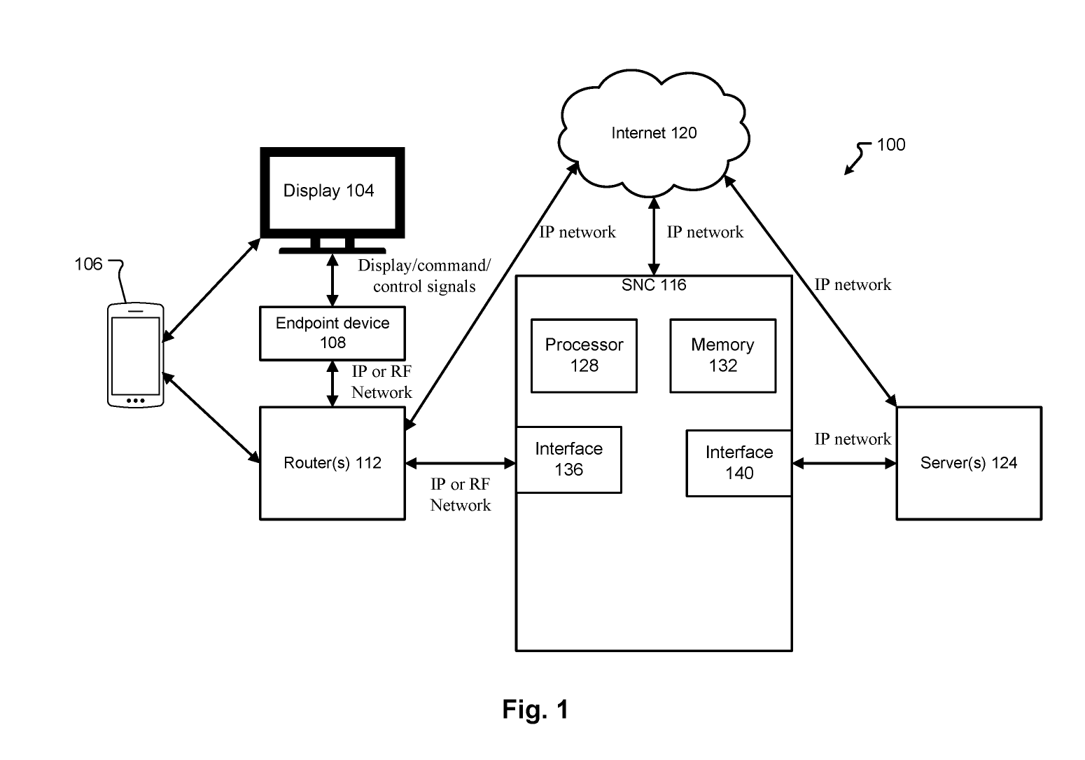

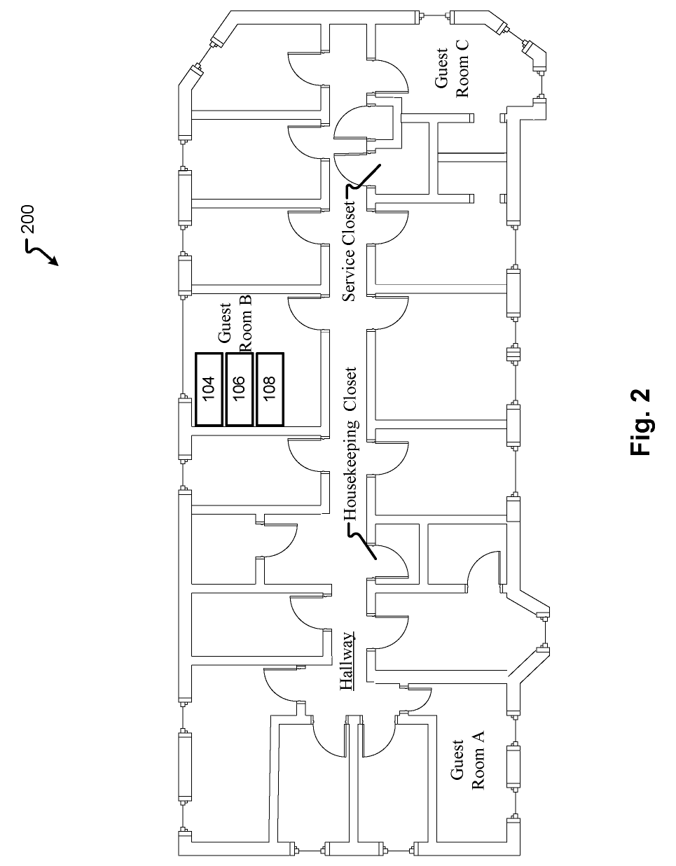

FIG. 1 illustrates a system 100 according to at least one example embodiment. The system 100 includes a display 104, a mobile device 106, an endpoint device 108, one or more routers 112, a system network at least one processor (SNC) 116, the Internet 120, and one or more servers 124. Elements of the system 100 may provide entertainment services to an environment or property 200 illustrated in FIG. 2. The property 200 may correspond to a managed facility where an entertainment provider has access to guest/tenant information by way of the guest or tenant inhabiting the property 200. Non-limiting examples of a property 200 include a dormitory, a time share, a condo, an apartment, a complex with multi-dwelling units (MDUs), an assisted-living facility, a hotel, a motel, an inn, and a healthcare facility (acute care hospital, clinic, hospice etc.).FIG. 2 illustrates an example that includes a plurality of guest or patient rooms A, B, C, etc. and other service related rooms. In this scenario, each guestroom in the property 200 may include a display 104, a mobile device 106 operable by a guest, and an endpoint device 108, as shown for guest room B, for example. A guestroom may further comprise a router 112 in some embodiments. In at least one embodiment, on-site routers 112 are located in service closets or other areas of the property 200 not easily accessible to guests.

A display 104 may comprise suitable hardware, software, and processing capability for reproducing audio and/or video content for consumption by a guest. For example, a display 104 may be implemented by a television (LED, LCD, etc.), a computer monitor, a tablet, a projector, and/or other device suitable for reproducing audio and/or video content. In some examples, the display 104 has RF components, such as a tuner for tuning to linear RF channels and/or over the air (OTA) channels. In other examples, the display 104 is a smart TV that has IP communication capabilities to communicate with other elements of the system 104. The display 104 may utilize the endpoint device 108 to communicate with other elements of system 104.

The mobile device 106 may correspond to a guest device that has computing and storage capabilities and that is generally mobile in nature. Accordingly, the mobile device 106 may be implemented with a smartphone, a laptop, a tablet, and/or the like.

The endpoint device 108 may comprise suitable hardware, software, and processing capability for providing a communications interface between a router 112 and the display 104. The endpoint device 108 may be integrated with the display 104 or exist as separate device.

An example of an endpoint device 108 includes a broadcast local area network (b-LAN) terminal connected to the display 104 and to translate signals routed between the display 104 and the router 112. In another embodiment, the endpoint device 108 may comprise an Internet Protocol (IP) client that translates signals routed between the display 104 and a router 112. Another example of an endpoint device 108 is a STB which passes command and control signals to/from the display 104 as well as display signals to the display 104.

The one or more routers 112 may comprise suitable hardware, software, and processing capability for providing communication between the mobile device 106, the endpoint device 108, the internet 120, and/or the SNC 116. A router 112 may be wireless in nature (e.g., a Wi-Fi router) and enable wireless communication between elements of the system 100. Additionally or alternatively, a router 112 may enable wired communication between elements of the system 100 (e.g., a router 112 may comprise an RF router for routing signals encoded with frequency-shift keying (FSK) techniques, a router 112 may comprise a network switch, such as an Ethernet switch, and/or the like). One or more routers may exist within the property 200 while one or more other routers are remote to the property 200 to communicate signals over long distances.

The SNC 116 may include suitable hardware, software, and processing capability for controlling various functions within the system 100. For example, the SNC 116 may include suitable processing circuitry, such as a processor 128 and a memory 132 including instructions that are executable by the processor 128 to carry out the various methods described herein. The memory 132 may correspond to any suitable type of memory device or collection of memory devices configured to store instructions. Non-limiting examples of suitable memory devices that may be used include flash memory, Random Access Memory (RAM), Read Only Memory (ROM), variants thereof, combinations thereof, or the like. In some embodiments, the memory 132 and processor 128 may be integrated into a common device (e.g., a microprocessor may include integrated memory). Additional or alternative suitable processing circuitry in the SNC 116 may include an application specific integrated circuit (ASIC), an Integrated Circuit (IC) chip, a Central Processing Unit (CPU), a Graphics Processing Unit (GPU), a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs. It should be appreciated that any appropriate type of electrical component or collection of electrical components may be suitable for inclusion in the processing circuitry 128.

The SNC 116 may further include communication interfaces 136 and 140 (also called interfaces herein) for enabling wired and/or wireless communication. The interface 136 may include suitable hardware or hardware and software for communicating with a network of the property 200 (which may be closed or private) while the interface 140 may include suitable hardware or hardware and software for communicating with a network outside the property 200 (e.g., the Internet). Although not explicitly shown, it should be appreciated that the other elements in FIG. 1 also include one or more communication interfaces for facilitating wired and/or wireless communication, internal or external to the property 200.

In at least one embodiment, the SNC 116 provides and controls access to entertainment options for guests within the system 100. Such entertainment options include but are not limited to viewing of live television programming, video on demand, room service, video games, and/or the like, all of which may be presented on a display 104. The SNC 116 can include or have access to content, such as stored movies, videos, menu screens, animations, audio content, and the like. The SNC 116 may access content through a third party content provider (e.g., through a streaming application). The SNC 116 may be installed and/or controlled by the entertainment provider which enables the entertainment options and controls guest access to such options (see FIG. 3). As discussed in more detail below, an SNC 116 may control functions related to the entertainment options under control of the SNC 116 for consumption by guests within the property 200.

The one or more servers 124 may comprise suitable hardware, software, and processing capability for enabling various functions within the system 100. In one embodiment, the one or more servers 124 have the same or similar components as the SNC 116. For example, a server 124 may comprise an application server that runs and/or provides application data to an application on mobile device 106 that is associated with the same entity that controls the SNC 116. In an embodiment according to FIG. 3, such an application enables pairing of a mobile device 106 to the SNC 116 to enable the mobile device 106 with certain controls of the display 104 (see US Patent No. 8,903,978, incorporated herein by reference, for details on pairing). Further, the servers 124 may comprise a server operated by a content provider (e.g., NETFLIX) that provides over the top (OTT) services such as streamed audio and/or video content to the display 104. More or fewer servers 124 may be included depending on implementation of the system 100.

The system 100 may be deployed in various configurations. In general, a property 200 includes the display 104, an endpoint device 108, router(s) 112, and one or more mobile devices 106. The SNC 116, however, may be local or remote to the property 200. For example, in one configuration, the SNC 116 is deployed remotely from the property 200 so that the SNC 116 may remotely control multiple environments 200 from a single location (e.g., in accordance with suitable cloud computing technologies). Here, troubleshooting and maintenance of a remotely located SNC 116 can occur at the single, remote location of the SNC 116. In another configuration, the SNC 116 is deployed local to the property 200, such as within a service closet of the property 200 or some other suitable location near or on-site the property 200. In this case, an SNC 116 may be located at each one of multiple environments 200. In yet another example, an SNC 116 may have some components located local to the property 200 and some components located remote to the property 200. The above described configurations of the SNC 116 may also apply to the router(s) 112 and/or a server within the server(s) 124 depending on design of the system 100.

Communication between elements of the system 100 may also have various configurations. For example, the router(s) 112, SNC 116, and/or server(s) 124 may communicate with one another over a closed or private network that does not involve the Internet such as a LAN (local area network) or WAN (wide area network) connection. In other embodiments, the Internet 120 facilitates communication between the routers 112, SNC 116, and/or the server(s) 124. Here, it should be appreciated that communication between the Internet, the SNC 116, and the server(s) 124 is generally IP communication. Meanwhile, the SNC 116, routers 112, endpoint device 108, and display 104 may be under control of the property’s 200 entertainment provider, and such communication between these elements may be entirely IP in nature, entirely RF in nature, or a blend of IP and RF. In some examples, the SNC 116 acts as an edge device for a property 200 which has the ability to manage (block, allow, modify) communications passing between the property 200 and the Internet 120.

It should be appreciated that the elements of the system 100 and property 200 are shown for the sake of explanation and that more or fewer elements may be included. In addition, one or more elements of the system 100 may be integrated with one or more other elements of the system 100. For example, the SNC 116 and an application server within server(s) 124 that is controlled by the same entity as the SNC 116 may be integrated with one another.

FIG. 3 illustrates a block diagram of elements used to carry out one or more methods of providing unified control of heterogeneous content within a hospitality environment. In more detail, FIG. 3 illustrates an STB 300 and a display device 304. The STB 300 may correspond to an example implementation of an endpoint device 108 in FIG. 1 while the display device 304 may be an example implementation of a display 104 (or TV) in FIG. 1. As described herein, the STB 300 and display device 304 are components which enable the entertainment provider to leverage existing content providing capabilities of the display device 304 (which may be an off-the-shelf TV, with or without “smart” technology) to provide a seamless entertainment experience within a guestroom of environment 200. For example, the STB 300 may render an electronic program guide (e.g., an interactive program guide (IPG)) to the display device 304 with multiple content options where some of the options are not capable of being provided by the STB 300 but are capable of being provided by the display device 304 and vice versa. Notably, the user remains unaware of which device is capable of providing which content options.

Some examples include determining whether the display device 304 can natively provide content selected from the program guide, and if so, the STB 300 leverages the display device’s 304 integrated tuning and decryption capabilities and instructs the display device 304 to natively provide the content, thereby eliminating the need for redundant hardware within the STB 300 (i.e., the STB 300 need not have hardware for handling the types of content that can be handled by the display device 304). For instance, a software application running on the STB 300 may dynamically determine whether the display device 304 can natively support content requested via selection of an item on the program guide and then send corresponding control signals to the display device 304 (e.g., if the display device 304 has native support for the requested content) and/or display signals to the display device 304 (e.g., if the display device 304 does not have native support for the requested content). The software application may be downloaded to the STB 300 on-property 200 by way of an on-site or off-site SNC 116 that also performs pairing of user devices to STBs/display devices or may be installed prior to on-property deployment. In any event, example embodiments allow for a unified user experience across diverse content sources.

Still with reference to FIG. 3 and to explain non-limiting examples of components of the system which enable the unified user experience, the STB 300 may comprise a processor 308, memory 312, and communication interfaces 316 and 320, and the display device 304 may comprise communication interfaces 324 and 328, a processor 332, memory 226, tuner(s) 340, and a display panel 344 which may correspond to an LCD display, an LED display, or other suitable display for displaying content.

The processors 308 and 332 may have the same or similar structure as the processor 128 described with reference to FIG. 1 to enable the STB 300 and display device 304 to carry out methods described herein. In addition, the memories 312 and 332 may have the same or similar structure as the memory 132 in FIG. 1 in order to allow their respective processors 308 and 332 to execute instructions or software stored thereon to carry out methods described herein. For example, memory 312 may comprise the aforementioned software application that dynamically determines whether the display device 304 can natively support requested content. Processor 308 may be capable of processing user commands, control signals from display device 304, and content, for example, by requesting content from SNC 116 or server(s) 124, decoding the content, decrypting the content, and/or formatting the content for sending as display signal over interface 320 for display on display panel 344. Processor 332 may have the same or similar capabilities to process user commands, control signals from STB 308, and content, for example, by requesting content from STB 300, SNC 116, or server(s) 124, decoding the content, decrypting the content, and/or formatting the content for display on display panel 344.

The interfaces 316 and 324 may correspond to command and control interfaces which pass commands and control signals between the STB 300 and the display device 304. Commands may correspond to user input to a remote control of the STB 300 and/or display device 304. Example commands may be to activate a program guide, select content on a program guide, channel up/down, volume up/down, select a series of numbers which correspond to a channel number, and/or the like. Control signals may correspond to signals generated by the STB 300 and sent to the display device to cause an effect at the display device 304 that corresponds to a command received by the STB 300. Control signals may further include signals generated by the display device 304 and sent to the STB to cause an effect at the STB 300 that corresponds to a command received by the display device 304. Thus, the interfaces 316 and 324 may be referred to as two-way communication interfaces. Non-limiting examples of interfaces 316 and 324 include an MTI/MPI interface, a USB to MTI/MPI interface, a serial interface (e.g., RS-232 interface), and/or other suitable interface for exchanging command and control signals.

Meanwhile, the interfaces 320 and 328 may correspond to interfaces for carrying display signals from the STB 300 to the display device 304, such as display signals which cause the display device 304 to display a program guide and/or content which is not natively supported by the display device 304. Thus, the interfaces 320 and 328 may be referred to as one-way communication interfaces. Non-limiting examples of interfaces 320 and 328 include an HDMI interface, a DisplayPort interface, VGA interface, a DVI interface, and/or other suitable interface for sending display signals to the display device 304.

The display device 304 may include one or more tuners 340 which cause the display device 304 to tune to a linear channel or an IP address. Thus, the one or more tuners 340 may comprise an RF tuner for tuning to RF channels providing content, an over the air (OTA) tuner for tuning to over the air broadcast channels providing content, and/or an IP tuner for tuning to IP addresses providing content. The type of tuner(s) 340 included in the display device 304 may vary across different environments 200 and may be one of the factors which affect the mapping of content options to capabilities of the STB 300, display device 304, or both.

The STB 300 and the display device 304 may have different capabilities for processing and providing content for output by the display device 304, which are represented in FIG. 3 by the circles labeled with types of content. In the example of FIG. 3, the STB 300 is capable of providing OTT services (e.g., subscription streaming services), IP cable TV, and IP encrypted satellite TV (e.g., non-Pro:Idiom encryption). On the other hand, the display device 304 is capable of providing RF and IP satellite TV with Pro:Idiom encryption (labeled “w/ P:I”), RF and IP cable TV w/ P:I, over the air (OTA) RF TV, and RF cable TV. However, the types of content capable of being provided by the STB 300 and the display device 304 may vary from the example shown in FIG. 3.

In at least one embodiment, the memory 312 of STB 300 stores a mapping 314 which maps content options to capabilities of the display device 304, the STB 300, or both. The mapping 314 may take the form of a table (e.g., a lookup table (LUT)) which maps each content option or a grouping of content options in the program guide with either the display device 304 or the STB 300. For example, the mapping 314 includes entries which associate content options which are natively supported by the display device 304 with the display device 304 and/or entries which associate content options which are not natively supported by the display device 304 but supported by the STB 300 with the STB 300. Although entries may exist for both the display device 304 and STB 300, it should be appreciated that some embodiments contemplate including entries only for content options natively supported by the display device 304. If a user’s selection of a content option cannot be associated with the display device 304, then the STB 300 may assume the selected content option is not natively supported by the display device 304 and proceed to generate a display signal with the selected content for sending to the display device 304.

FIG. 4 illustrates a method 400 for providing unified control of heterogenous content according to at least one example embodiment. The method 400 may be performed by one or more elements described with reference to FIGS. 1-3. For example, the method 400 may be carried out by the STB 300 with aid of other components shown and described with reference to the figures.

Step 404 includes receiving a user command corresponding to a request for content to be output by a display device 304. For example, the STB 300 receives the user command by way of user input to a remote control of the display device 304 which selects a content option from a program guide (e.g., an electronic program guide, which may be interactive) generated by the STB 300 and sent as a display signal over interface 320 so as to be displayed on the display device 304. Stated another way, prior to step 404, the method may include causing the display device 304 to render an electronic program menu via interface 320, where the electronic program menu comprises content options for viewing by a user of the display device 304. The user input to the remote control may select one of the content options from the program guide, with such user input being detected by the display device 304 and/or the STB 300 and passed on/processed as the user command corresponding to the request for content.

Step 408 may include determining, based on the user command, whether the display device 304 natively supports providing the content requested in step 404. For example, the STB 300 determines whether the display device 304 natively supports providing the content by accessing the mapping 314 which maps content options to capabilities of the display device 304, the STB 300, or both. In some examples, the STB 300 determines that the mapping 314 contains an entry which matches the requested content with the display device 304, meaning that the display device 304 has the capability to natively provide (e.g., decode and/or decrypt and display) the requested content. In other examples, the STB 300 determines that the mapping 314 either lacks an entry which maps the requested content to the display device 304 or includes an entry which maps the requested content to the STB 300, meaning that the display device 304 cannot natively provide the requested content and that the STB 300 should handle providing the content (e.g., by decoding and/or decrypting a content signal from SNC 116 or server(s) 124 and formatting the content signal as a display signal containing the content).

Step 412 includes generating and sending, when step 408 determines that the display device 304 natively supports providing the content, at least one control signal through a first communication interface 316 of the STB 300 to control the display device 304 to natively provide the content. The at least one control signal may cause a tuner 340 of the display device 304 to tune to the content. As noted in FIG. 3, depending on the type of content, the tuner 340 may comprise a QAM tuner for tuning to a linear channel comprising the content, an IP tuner for tuning to an IP address comprising the content, and/or an over the air tuner (e.g., 8VSB tuner).

In some embodiments, the at least one control signal causes the display device 304 to switch inputs (also known sources, input sources, and the like) from an input connected to a second communication interface 320 of the STB 300 to an input connected to the tuner 340 of the display device 304. Thus, the display device 304 switches from displaying the program guide provided by the STB 300 to displaying the content tuned to by the tuner 340. Switching inputs as described herein should be understood as an operation which causes the display device 304 to switch its internal source from one source (e.g., a tuner) to another source (e.g., the interface 320).

Step 416 includes generating and sending, when step 408 determines that the display device 304 does not natively support providing the content, a display signal including the content through the second communication interface 320 of the STB 300 to cause the display device 304 to output the content. As may be appreciated, step 416 may include decoding, and if applicable, decrypting, a content signal comprising the content.

Thus far, FIG. 4 has been described with reference to a scenario where the user command is corresponds to a selection of a content option presented in a program guide provided by the STB 300 and displayed on display device 304. However, example embodiments are not limited thereto and at least some parts of the method 400 may apply if the user command for requesting content is initiated and received when the program guide is not being displayed. For example, the user command may be to channel up or down from a current channel to a new channel without involvement of the program guide. If the new channel is determined to not be natively supported by the display device 304 in step 408, then step 416 may be applied. However, if step 408 determines that the display device 304 natively supports providing the content of the new channel, the at least one control signal in step 412 may be omitted, for example, if the new channel is from a same input source as the old channel (e.g., the old channel and the new channel are both provided by a same tuner 340). If the new channel is from a different input source, such as a different tuner 340, but its content is still capable of being natively provided by the display device 304, then the display device 304 may switch to the different input source. Since the different input source is “native” to the display device 304, the display device 304 may implement the switch with an “internal” control signal and without an explicit control signal from the STB 300, such as when the display device 304 is capable of processing the user command to change channels. Though it is also possible for the STB 300 to send a control signal that causes the display device 304 to switch tuners 340, such as in a scenario where the STB 300 is responsible for processing the user command to change channels.

Still with reference to the scenario that does not involve the program guide but where the user command is to change from an old channel natively supported by the display device 304 to a new channel not natively supported by the display device 304, then step 416 is applied so that the STB 300 generates and sends a display signal with the content of the new channel through interface 320. Here, as part of or in conjunction with step 416, the STB 300 may instruct, by way of a control signal through the interface 316, the display device 304 to switch inputs from an input connected to a tuner 340 of the display device 304 to an input connected to the interface 320 of the STB 300 so that the new channel is displayed on the display device 304. Such a control signal may be sent before or at the same time as the display signal having the content of the new channel. Of course, if both the old channel and the new channel are supported by the STB 300 and not the display device 304, then the control signal to switch inputs is not needed because the display device 304 is already outputting content received from interface 320 of the STB 300.

In view of the above, it should be appreciated that at least one embodiment is directed to a system that includes a device (e.g., an STB 300) having a first communication interface 316 for sending control signals to a display device 304 and a second communication interface 320 for sending display signals to the display device 304. At least one processor of the device may cause the display device 304 to render an electronic program menu to the display device via the second interface 320, where the electronic program menu comprises content options for viewing by a user of the display device 304. The at least one processor may, in step 404, receive a signal corresponding to a user command that selects a content option from the electronic program menu, determine whether the display device 304 natively supports providing content of the selected content option based on a mapping of the content options to capabilities of the display device 304, the device, or both, and then utilize, based on the determination, the first communication interface 316, the second communication interface 320, or both to provide the content to the display device 304. For example, when step 408 the display device natively supports providing the content, the at least one processor is to utilize only the first communication interface 316 by at least one of causing the display device 304 to select an input connected to a tuner 340 of the display device 304, or causing the tuner 340 of the display device 304 to tune to the content. In other cases, such as when step 408 determines that the display device 304 does not natively support providing the content and an input of the display device 304 is connected to a tuner 340 of the display device 304, the at least one processor is to utilize the first communication interface 316 and the second communication interface 320 by sending a control signal via the first communication interface 316 to cause the display device 304 to switch from the input connected to the tuner to an input connected the second communication interface 320, and sending, to the display device 304 via the second communication interface 320, a display signal comprising the content. In yet other cases, such as when step 408 determines that the display device 304 does not natively support providing the content and an input of the display device 304 is connected to the second communication interface 320, the at least one processor is to utilize only the second communication interface 320 to send a display signal comprising the content to the display device 304.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable, and/or equivalent structures, functions, ranges, or steps to those claimed, whether or not such alternate, interchangeable, and/or equivalent structures, functions, ranges, or steps are disclosed herein, and without intending to publicly dedicate any patentable subject matter.

What is claimed is:

1. A system, comprising:
a set-top-box (STB) comprising:
a first communication interface;
a second communication interface;
memory comprising instructions; and
at least one processor to execute the instructions to:
receive a user command corresponding to a request for content to be output by a display device;
determine, based on the user command, whether the display device natively supports providing the content;
generate and send, when the display device natively supports providing the content, at least one control signal through the first communication interface of the STB to control the display device to natively provide the content; and
generate and send, when the display device does not natively support providing the content, a display signal including the content through the second communication interface of the STB to cause the display device to output the content.

2. The system of claim 1, wherein the first communication interface is a two-way communication interface between the STB and the display device, and wherein the second communication interface is a one-way communication interface from the STB to the display device.

3. The system of claim 1, wherein the memory further comprises instructions which the at least one processor executes to determine whether the display device natively supports providing the content by accessing a mapping which maps content options to capabilities of the display device, the STB, or both.

4. The system of claim 1, wherein the at least one control signal causes a tuner of the display device to tune to the content.

5. The system of claim 4, wherein the tuner comprises a QAM tuner for tuning to a linear channel comprising the content.

6. The system of claim 4, wherein the tuner comprises an IP tuner for tuning to an IP address comprising the content.

7. The system of claim 4, wherein the at least one control signal causes the display device to switch inputs from an input connected to the second communication interface of the STB to an input connected to the tuner of the display device.

8. The system of claim 4, further comprising:
the display device, wherein the memory further comprises instructions which the at least one processor executes to cause the display device to render an electronic program menu to the display device via the second communication interface, the electronic program menu comprising content options for viewing at the display device.

9. The system of claim 1, wherein generating and sending the display signal comprises decoding a content signal comprising the content.

10. The system of claim 9, wherein generating and sending the display signal comprises decrypting the content signal.

11. The system of claim 1, wherein the memory further comprises instructions which the at least one processor executes to instruct the display device to switch inputs from an input connected to a tuner of the display device to an input connected to the second communication interface of the STB in conjunction with generating and sending the display signal.

12. The system of claim 11, wherein the memory further comprises instructions which the at least one processor executes to send the instruction to switch inputs to the display device through the first communication interface of the STB.

13. A method, comprising:
receiving, by a set-top-box (STB), a user command corresponding to a request for content to be output by a display device;
determining, by the STB and based on the user command, whether the display device natively supports the content;
generating and sending, when the display device natively supports the content, at least one control signal through a first communication interface of the STB which causes a tuner of the display device to tune to the content; and
generating and sending, when the display device does not natively support the content, a display signal including the content through a second communication interface of the STB to cause the display device to output the content.

14. The method of claim 13, wherein determining whether the display device natively supports providing the content includes accessing a mapping which maps content options to capabilities of the display device, the STB, or both.

15. The method of claim 13, wherein the at least one control signal causes the display device to switch inputs from an input connected to the second communication interface of the STB to an input connected to the tuner of the display device.

16. The method of claim 13, further comprising:
causing the display device to switch inputs from an input connected to the tuner of the display device to an input connected to the second communication interface of the STB in conjunction with generating and sending the display signal.

17. A system, comprising:
a first communication interface for sending control signals to a display device;
a second communication interface for sending display signals to the display device;
memory comprising instructions; and
at least one processor to execute the instructions to:
cause the display device to render an electronic program menu via the second communication interface, the electronic program menu comprising content options for viewing by a user of the display device;
receive a signal corresponding to a user command that selects a content option from the electronic program menu;
determine whether the display device natively supports providing content of the selected content option based on a mapping of the content options to capabilities of the display device; and
utilize, based on the determination, the first communication interface, the second communication interface, or both to provide the content to the display device.

18. The system of claim 17, wherein, when the display device natively supports providing the content, the at least one processor is to utilize only the first communication interface by at least one of:
causing the display device to select an input connected to a tuner of the display device; or
causing the tuner of the display device to tune to the content.

19. The system of claim 17, wherein, when the display device does not natively support providing the content and an input of the display device is connected to a tuner of the display device, the at least one processor is to utilize the first communication interface and the second communication interface by:
sending a control signal via the first communication interface to cause the display device to switch from the input connected to the tuner to an input connected the second communication interface; and
sending, to the display device via the second communication interface, a display signal comprising the content.

20. The system of claim 17, wherein, when the display device does not natively support providing the content and an input of the display device is connected to the second communication interface, the at least one processor is to utilize only the second communication interface to send a display signal comprising the content to the display device.
